(19) United States
(12) Patent Application Publication
(10) Pub. No.: US 2026/0310213 A1
(43) Pub. Date: Oct. 8, 2026

(54) LOGISTICS SYSTEM AND CONTROL DEVICE THEREFOR

(71) Applicants: Hyundai Motor Company, Seoul (KR); Kia Corporation, Seoul (KR)

(72) Inventors: Beom Jun LEE, Gyeonggi-do (KR); Kyung Dong PARK, Gyeonggi-do (KR); Kye Un AHN, Gyeonggi-do (KR); Sang Won YOON, Gyeonggi-do (KR)

(21) Appl. No.: 19/484,842

(22) PCT Filed: Dec. 18, 2023
(86) PCT No.: PCT/KR2023/020887

§ 371 Date: Nov. 14, 2025

(30) Foreign Application Priority Data
Jun. 26, 2023 (KR) 10-2023-0081974

(51) Int. Cl. G05D 1/617; G05D 1/246; G05D 1/65; G05D 1/69; G05D 107/70; G06Q 10/08

(52) U.S. Cl. CPC G05D 1/617; G05D 1/246; G05D 1/65; G05D 1/69; G06Q 10/08; G05D 2107/70

(57) ABSTRACT

Disclosed are a logistics system and a control device therefor, the system comprising: a map management unit for setting at least one region within an operation boundary as region of interest on the basis of map information corresponding to a preset operation boundary ; and a monitoring unit for determining whether a logistics robot has entered the set region of interest, and instructing that the logistics robot adjusts the adjacent recognition range thereof on the basis of the determination result of whether entering has occurred.

### TECHNICAL FIELD

The present disclosure relates to a logistics system and a control device therefor for enabling a logistics robot to move efficiently within an operation boundary.

### BACKGROUND ART

Logistics robots have been introduced for flexible and efficient supply and transport of components and the like, not only in general logistics warehouses and factories, but also in smart factories that manufacture goods with specifications different from each other using various components.

The logistics robot is a concept collectively referring to an autonomous mobile robot (AMR) and an automated guided vehicle (AGV), and such a logistics robot can perform movements and operations under the control of a control system.

In a smart factory, the logistics robot moves along an optimal movement route based on path planning in order to perform a mission assigned by a control device.

Meanwhile, there may be a collision between each other in the process where a plurality of logistics robots moves along each movement route. In the event of a collision with a logistics robot, the logistics robot is damaged, causing damage, and the process is delayed, which can cause significant disruption to the entire process.

To prevent such damage, methods such as controlling the logistics robot to slow down or performing avoidance driving may be applied when the logistics robot and another object are in close proximity. However, there may be cases where the logistics robot and another object are in close proximity but do not actually collide, in which case the movement efficiency of the logistics robot may be reduced due to the control such as deceleration driving and avoidance driving for preventing collisions.

The matters described above as the background technology are only intended to enhance an understanding of the background of the present disclosure, and should not be construed as acknowledging that it corresponds to the prior art already known to those skilled in the art.

### DETAILED DESCRIPTION OF THE INVENTION

### Technical Problem

The objective of the present disclosure is to provide a logistics system and a control device therefor for enabling a logistics robot to move efficiently by adjusting an adjacent recognition range, which is a criterion for determining a collision prediction of a logistics robot, on the basis of map information about an operation boundary, thereby securing the efficiency of the logistics system.

Technical tasks of the present disclosure are not limited to the technical tasks mentioned above, and other technical tasks not mentioned may be clearly understood by those skilled in the art from the following description.

### Means for Solving the Problem

A control device according to an exemplary embodiment of the present disclosure for realizing the task described above includes a map management unit for setting at least one region within an operation boundary as a region of interest on the basis of map information corresponding to a preset operation boundary, and a monitoring unit for determining whether a logistics robot enters the set region of interest and for directing to adjust an adjacent recognition range of the logistics robot on the basis of a determination result of whether to enter.

A logistics system according to an exemplary embodiment of the present disclosure for realizing the task described above includes a logistics robot for moving within a preset operation boundary and for detecting an object within an adjacent recognition range through a sensor provided therein, and a control device for setting at least one region within the operation boundary as a region of interest on the basis of map information corresponding to the operation boundary, for determining whether the logistics robot enters the at least one region of interest, and for directing to adjust the adjacent recognition range on the basis of a determination result of whether to enter.

A logistics system according to an exemplary embodiment of the present disclosure for realizing the task described above includes a logistics robot for moving within a preset operation boundary and for detecting an object within an adjacent recognition range through a sensor provided therein, and a control device for setting at least one region within the operation boundary as a region of interest on the basis of map information corresponding to the operation boundary, and for transmitting the region of interest to the logistics robot, wherein the logistics robot determines whether to enter the region of interest and directs to adjust the adjacent recognition range of the logistics robot on the basis of a determination result of whether to enter.

### Effects of the Invention

According to various exemplary embodiments of the present disclosure as described above, it is possible to efficiently perform the control of collision avoidance of a logistics robot by adjusting an adjacent recognition range, which is a criterion for determining a collision prediction by reflecting features for each region within an operation boundary.

In particular, it is possible to prevent a logistics robot from slowing down because of unnecessarily performing the control of collision prevention by reducing an adjacent recognition range when the risk of collision is low, thereby improving the movement efficiency of the logistics robot.

In addition, it is possible to improve the movement efficiency of the logistics robot while effectively preventing collisions of logistics robots, by expanding an adjacent recognition range when the risk of collision is high.

Furthermore, it is possible to improve the efficiency of a logistics system, to which the logistics robot is applied, by improving the movement efficiency of the logistics robot.

The effects obtainable from the present disclosure are not limited to the effects mentioned above, and other effects not mentioned will be clearly understood by those skilled in the art to which the present disclosure belongs from the description below.

### BRIEF DESCRIPTION OF DRAWINGS

FIG. 1 is a block diagram illustrating an example of an operation boundary configuration of a logistics system applicable to exemplary embodiments of the present disclosure.

FIG. 2 is a block diagram illustrating an example of a control device configuration applicable to exemplary embodiments of the present disclosure.

FIG. 3 is a block diagram illustrating an example of a logistics robot configuration applicable to exemplary embodiments of the present disclosure.

FIGS. 4a through 4d are views illustrating adjustment of an adjacent recognition range according to exemplary embodiments of the present disclosure.

FIGS. 5 to 6 are sequence diagrams of a logistics system according to exemplary embodiments of the present disclosure.

### MODE FOR CARRYING OUT THE INVENTION

Specific structural and functional descriptions for exemplary embodiments of the present disclosure disclosed in the present specification or application are merely illustrative for the purpose of explaining the exemplary embodiments according to the present disclosure, and the exemplary embodiments according to the present disclosure may be practiced in various forms and should not be construed as limited to the exemplary embodiments described in the present specification or application.

Because the exemplary embodiments according to the present disclosure can have various changes and can have various forms, specific exemplary embodiments may be illustrated in the drawings and may be described in detail in the present specification or application. However, this may not be intended to limit an exemplary embodiment according to the concept of the present disclosure to a specific disclosed form, but should be understood to include all modifications, equivalents, or substitutes included in the spirit and technical scope of the present disclosure.

In the description of the following exemplary embodiments, the term “preset” may mean that a numerical value of a parameter is predetermined when the parameter is used in a process or algorithm. The numerical value of the parameter may be set when the process or algorithm starts or may be set during a region in which the process or algorithm is performed according to an exemplary embodiment.

Unless otherwise defined, all terms used herein, including technical or scientific terms, may have the same meaning as commonly understood by one of ordinary skill in the art to which the present disclosure belongs. Terms such as those defined in a generally used dictionary should be interpreted as having a meaning consistent with the meaning of the context of the relevant technology and should not be interpreted in an idealized or overly formal sense unless explicitly defined in the present specification.

Hereinafter, the exemplary embodiments disclosed in the present specification will be described in detail with reference to the attached drawings, and regardless of the drawing symbols, identical or similar components will be assigned the same reference numerals and redundant descriptions thereof will be omitted.

The suffixes “module” and “unit” for components used in the following description may be assigned or used interchangeably only for the convenience of writing the specification, and do not have a distinct meaning or role in and of themselves.

In describing an exemplary embodiment disclosed in the present specification, the detailed description thereof may be omitted when it is determined that a detailed description of the related known technology may obscure the gist of the exemplary embodiment disclosed in the present specification. In addition, the accompanying drawings may be only intended to facilitate the understanding of the exemplary embodiment disclosed in the present specification, and the technical idea disclosed in the present specification may not be limited by the accompanying drawings and should be understood to include all modifications, equivalents, or substitutes included in the spirit and technical scope of the present disclosure.

Terms including ordinal numbers, such as a first and second, may be used to describe various components, but the components may not be limited by the terms. The terms may be used only for the purpose of distinguishing one component from another component.

When it is mentioned that a component is “connected” or “linked” to another component, it should be understood that the component may be directly connected or linked to the other component, but another component may be interposed therebetween. On the other hand, when it is mentioned that a component is “directly connected” or “directly linked” to another component, it should be understood that no other component exists in the middle.

Singular expressions may include plural expressions unless the context clearly indicates otherwise.

In the present specification, terms such as “include” or “have” may be intended to specify the existence of features, numbers, steps, operations, components, parts, or combinations thereof described in the specification, which should be understood not to preclude the existence or addition of one or more other features, numbers, steps, operations, components, parts, or combinations thereof.

The controller may include a modem/transceiver for communicating with other control devices or sensors in order to control functions in charge, a memory for storing operating systems or logic commands and input/output information, and one or more processors for performing determination, calculation, and decision necessary to control functions in charge.

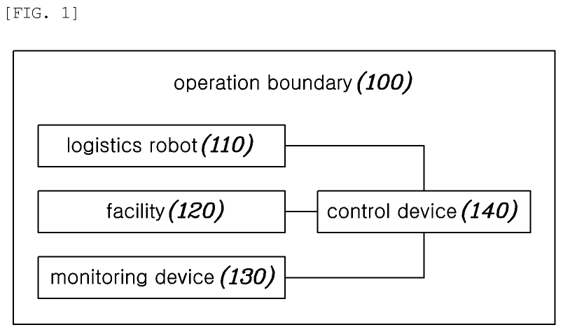

First, a configuration of an operation boundary in which a logistics robot is arranged and operated according to an exemplary embodiment will be described with reference to FIG. 1.

Referring to FIG. 1, the operation boundary 100 may include a logistics robot 110, a facility 120, a monitoring device 130, and a control device 140.

The operation boundary 100 may be equipped with a plurality of logistics robots 110, a plurality of facilities 120, and a plurality of monitoring devices 130 depending on the production process and the target production speed of the product. The operation boundary 100 may be implemented as a smart factory, and the plurality of facilities may be implemented as a production device, but may not be necessarily limited thereto. hereinafter, each component will be described.

First, the logistics robot 110 may include an autonomous mobile robot (hereinafter, referred to as an “AMR” for convenience) and an automated guided vehicle (hereinafter, referred to as an “AGV” for convenience). According to an operation policy of the logistics robot 110, only one type of either the AGV or the AMR may be operated within the operation boundary 100, or both the AGV and the AMR may be operated together within the operation boundary 100.

The AGV may generally perform the operations (movement, direction change, stop, etc.) required within the operation boundary 100 by recognizing and following the guide facility arranged on the floor for guiding the AGV. Herein, the guide facility may refer to optically recognizable markers (spots, 2D codes, etc.), tags recognizable in a non-contact manner at a short distance (e.g., NFC tags, RFID tags, etc.) , magnetic strips, wires, and the like, but this may be exemplary and may not be necessarily limited thereto. The guide facility may be arranged continuously on the floor or may be arranged to be discontinuously spaced apart from each other. Since the AGV basically performs operations by recognizing and following the guide facility, it is required that the guiding facility be installed in advance before operation, so it is necessary to physically establish or modify the guide facility when moving the AGV to a new route or modifying the existing route before operation. In addition, the AGV does not deviate from the route set through the guide facility, so it is common to stop when an obstacle is detected on or around the route until the detected obstacle is removed or separate control is provided. In the operation of the AGV, the control device 140 should control the AGV on the basis of the guidance facility, so may transmit the commands such as “driving until the third marker is recognized” and “switching the heading direction by 90 degrees when the third marker is recognized” to the AGV either as individual command units or as mission (e.g., retrieval, supply, charging, patrol, etc.) units including a plurality of commands.

The AMR may determine (i.e., positioning) the current location by detecting the surroundings, and the point, at which path planning is possible by using positioning and a map, is the most distinguishing point from the AGV. Therefore, when the AMR and the control device 140 share a map in which coordinates are compatible with each other, the control device 140 may control the AMR in a manner of directing the AMR on the basis of the coordinates. In addition, when detecting an obstacle while driving, the AMR may set an avoidance route on its own, avoid the obstacle, and return to the existing route. The function of setting the AMR route to one or more waypoint coordinates by the control device 140 may be referred to as global path planning, and the function of setting a movement route or an avoidance route between the waypoint coordinates according to the global path planning may be referred to as local path planning.

Next, the facility 120 may refer to, for example, a device (e.g., robot arm, conveyor belt, etc.) that performs the production process of the product within the operation boundary 100 and, in a broader sense, may refer to a device arranged to assist in performing missions such as entry and exit of a logistics robot 110 when the production process is performed by a person. The device arranged to assist in performing missions may be a device for detecting the state of a designated location where a pallet carried by a logistics robot 110 can be put down or collected within an area where a specific production process is performed, a device for determining the degree of the process progress, and a means for blocking entry and exit within an area, etc., but is not necessarily limited thereto.

For example, the facility 120 may be controlled through a programmable logic controller (PLC) and can communicate with the control device 140 in relation to the process progress.

The monitoring device 130 may perform a function of obtaining information for determining a situation within the operation boundary 100 and transmitting the information to the control device 140. For example, the monitoring device 130 may include a camera, a proximity sensor, and the like, but may not be necessarily limited thereto.

The control device 140 may communicate with the aforementioned components 110, 120, 130 to obtain information necessary for operating the operation boundary 100 or control each component. For example, the control device 140 may perform the dispatching, route setting, mission assignment, process management for each product, material management, and the like of the logistics robot 110.

In implementations, the control device 140 may include a local control device (ACS: AMR/AGV Control System) for controlling surrounding process facilities on the basis of the locations of the AGVs/AMRs and performing mission-based control of the AGVs/AMRs, and an integrated control device (MORIMS: Mobile Robot Integrated Monitoring System) for integrating and controlling two or more local control devices. The integrated control device may perform the state and route, logistics flow setting, and traffic control of all logistics robot 110 in the operation boundary 100 from each of the plurality of local control devices. For example, when the local control device (ACS) is equipped as a logistics robot unit of the same manufacturer or the same model, the integrated control device may perform integrated control for collision prevention, such analysis of bottleneck levels in intersection/overlapping areas, driving acceleration/deceleration control, and regeneration of avoidance routes, through heterogeneous traffic distribution control on the basis of information obtained through the plurality of local control devices (ACS).

Further, the integrated control device may have a manufacturing execution system (MES) as a higher-level control entity, and the manufacturing execution system (MES) may be again linked to the advanced planning & scheduling (APS).

In addition to the configurations 110, 120, 130, 140 of the aforementioned operation boundary 100, it is obvious that a device for intercommunication between components such as beacons, repeaters, APs (Access Point), a charger for charging the logistics robot 110, a loading space for storing or loading parts, a space for storing finished products intermediate products, traffic lights, breakers, and a waiting space for idle logistics robots 110 can be properly arranged within the operation boundary 100.

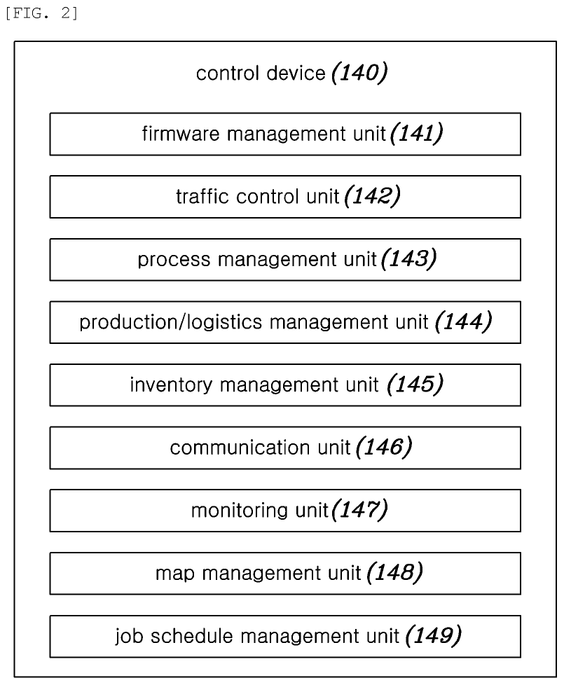

Hereinafter, a configuration of the control device 140 applicable to exemplary embodiments of the present disclosure will be described with reference to FIG. 2.

FIG. 2 is a block diagram illustrating an example of a control device configuration applicable to exemplary embodiments of the present disclosure. Each component shown in FIG. 2 mainly shows components in relation to exemplary embodiments of the present disclosure, and more or fewer components may be included in the actual implementation of the control device 140.

Referring to FIG. 2, the control device 140 may include a firmware management unit 141, a traffic control unit 142, a process management unit 143, a production/logistics management unit 144, an inventory management unit 145, a communication unit 146, a monitoring unit 147, a map management unit 148, and a job schedule management unit 149.

The firmware management unit 141 may obtain the latest firmware of the logistics robot 110 through the communication unit 146 and transmit the same to the logistics robot 110 to perform a firmware update, thereby maintaining the firmware of the logistics robot 110 up to date.

The traffic control unit 142 may control the traffic light and the breaker on the basis of the route of the logistics robot 110, and may recalculate the route of the logistics robot 110 according to traffic.

The process management unit 143 may define a process for each product and may manage missions such as the degree of the process progress and a progress location.

The production/logistics management unit 144 may dispatch the logistics robot 110 on a mission basis.

The inventory management unit 145 may manage the location and quantity for each material, and this information may be useful for more efficient process operation, such as allowing the logistics robot 110 to depart for a destination in advance for pallet pickup or retrieval before the actual assembly or consumption of the materials is detected.

The communication unit 146 may perform communication with not only internal components of the operation boundary 100, such as the logistics robot 110, the facility 120, and the monitoring device 130, but also external entities, such as a firmware update server.

The monitoring unit 147 may monitor the location, route, battery state, communication state, power train state, and the like of the individual logistics robot 110. Herein, the route may be a concept including a waypoint-based global route and a real-time local route. In addition, the battery state may include voltage, current, temperature, peak values of voltage and current, state of charge (SOC), state of health (SOH), and the like. The communication state may include information about a currently activated communication protocol (such as Wi-Fi), a connected AP, a distance to the AP, a channel in use, and the like. Further, the power train state may include a load, temperature, RPM, and the like of the drive system.

Besides, the monitoring unit 147 may identify the mission, operation mode, firmware version, and the like currently assigned to the individual logistics robot 110.

The map management unit 148 may obtain map data in the form of a grid map obtained by the AMR among the logistics robots 110 while driving inside the operation boundary 100, and provide a tool for a factory manager to edit on the basis of the obtained map data. Through the editing of the map information, zones for performing one or more preset operations, virtual lanes, intersections, and entry-restricted zones may be set when the logistics robot 110 enters, but this is illustrative and is not necessarily limited thereto. In addition, the map management unit 148 may distribute the initially obtained grid map to the other logistics robots 110 through the communication unit 146 other than the smart logistics vehicle 110 that obtains the corresponding map through actual driving.

The job schedule management unit 149 may manage and monitor the missions of the logistics robot 110 on the basis of the process information of the operation boundary 100 received from the facility 120 and the monitoring device 130 through the communication unit 146. In addition, the job schedule management unit 149 can select a specific logistics robot 110 to assign a mission, and may set the global route of the logistics robot 110 according to the assigned mission.

Meanwhile, in an exemplary embodiment of the present disclosure, the map management unit 148 may set at least one region within the operation boundary 100 as a region of interest on the basis of map information corresponding to the operation boundary 100.

In this case, the map information may include the location of each region within the operation boundary 100, the number of another fixed object for each region, the width of the route along which the logistics robot 110 moves for each region, the number of times another object moves for each region, the set speed of the logistics robot for each region, and the type of another object for each region.

In addition, the information about the facility 120, such as facility logistics dispensing information, may be reflected in the map information and the information about the facility 120 may be obtained from the facility 120 through the communication unit 146.

By setting the region of interest on the basis of the map information as described above, the map management unit 148 may allow the features of each region within the operation boundary to be reflected in the adjustment of the adjacent recognition range of the logistics robot 110.

The monitoring unit 147 may determine whether the logistics robot 110 enters the set region of interest, and may direct to adjust the adjacent recognition range of the logistics robot 110 on the basis of the determination result of whether to enter.

More specifically, the monitoring unit 147 may determine whether the logistics robot 110 enters the region of interest within the operation boundary 100 on the basis of the location of each region within the operation boundary 100 and the location of the logistics robot 110. Herein, the location of each region within the operation boundary 100 may be included in the map information as described above, and the location of the logistics robot 110 may be obtained from the logistics robot 110 or from the monitoring device 130.

In addition, the monitoring unit 147 may direct to adjust the adjacent recognition range of the logistics robot 110 by transmitting a control signal corresponding to the determination result of whether to enter to the logistics robot 110.

In this case, the control signal may be output through the communication unit 146 of the control device 140, and the logistics robot 110 receiving the output control signal may adjust the adjacent recognition range.

Meanwhile, the region of interest may include a plurality of regions and may include at least a first region of interest and a second region of interest. In this case, the monitoring unit 147 may direct to adjust the adjacent recognition range when the logistics robot 110 enters the region of interest, but may direct to differently adjust the adjacent recognition range according to which of the plurality of regions of interest the logistics robot 110 enters.

More specifically, when the logistics robot 110 enters the first region of interest, the monitoring unit 147 may direct to reduce the adjacent recognition range to at least one side. In this case, the first region of interest may be set in consideration of at least one of the location of the another fixed object for each region and the width of the route along which the logistics robot 110 moves for each region.

In contrast, when the logistics robot 110 enters the second region of interest, the monitoring unit 147 may expand the adjacent recognition range to at least one side. In this case, the second region of interest may be set in consideration of at least one of the number of movements of the another object for each region, the set speed of the logistics robot 110 for each region, and the type of the another object for each region.

In addition, when the logistics robot 110 entering the region of interest deviates the region of interest, the monitoring unit 147 may direct to readjust the adjacent recognition range back to before the adjustment.

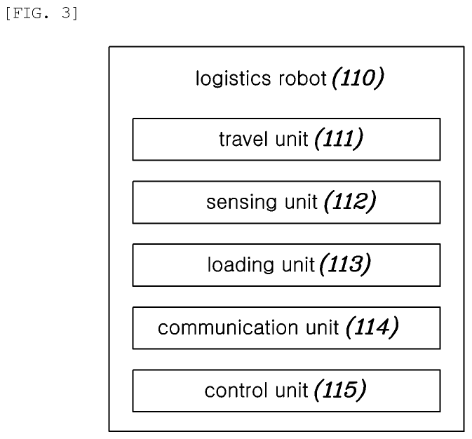

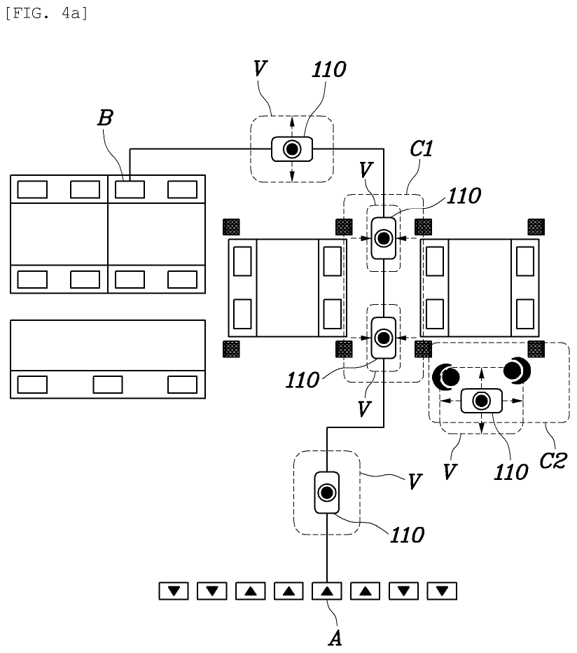

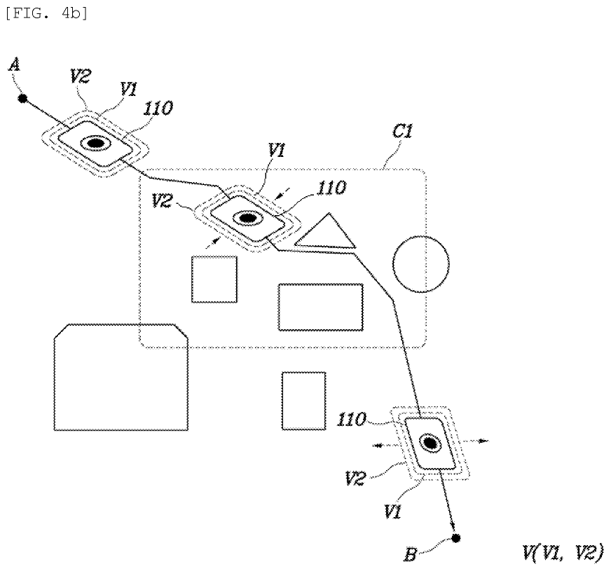

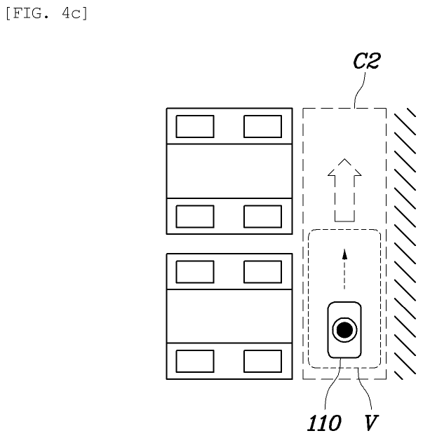

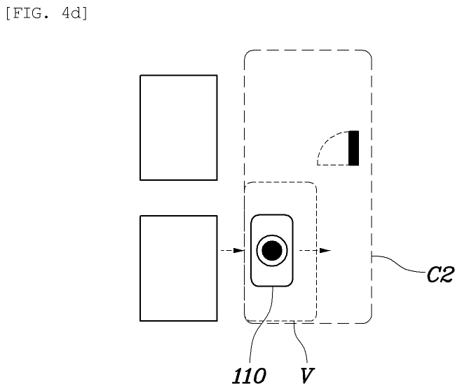

More detailed information in relation to adjustment of the adjacent recognition range will be described later with reference to FIGS. 4a and 4b, and next, the logistics robot will be described first with reference to FIG. 3.

FIG. 3 is a block diagram illustrating an example of a logistics robot configuration applicable to exemplary embodiments of the present disclosure.

Referring to FIG. 3, the logistics robot 110 may include a travel unit 111, a sensing unit 112, a loading unit 113, a communication unit 114, and a control unit 115. Hereinafter, each component will be described.

The travel unit 111 may include a driving source, a wheel, a suspension, and the like, which are involved in the movement, steering, and stopping of the logistics robot 110. The driving source may utilize an electric motor supplied with power from a built-in battery (not shown). The wheel may include one or more driving wheels that receive driving force from the driving source, and a non-driving wheel that rotates by the movement of the vehicle body without receiving the driving force. Depending on the implementations, the rotation of each driving wheel may be independently controlled when a plurality of driving wheels are provided and the driving source is matched for each driving wheel. In this case, by varying the rotation directions of driving wheels different from each other, the vehicle body may be rotated to enable steering without a separate steering means. At least some of the non-driving wheels may be configured as caster-type wheels, but this is illustrative and is not necessarily limited thereto.

The sensing unit 112 may be for sensing the surrounding environment of the logistics robot 110 or a state of its own operation, and may include at least one of a 2D laser scanner (e.g., LiDAR), a 3D vision (stereo) camera, a multi-axis gyro sensor, an acceleration sensor, a wheel encoder, and a proximity sensor.

The encoder may output information for determining how much the wheel is rotated by using light emitted from a light emitting element (e.g., a photodiode). For example, the encoder may count the number of slits disposed along the circumferential direction on the wheel or the disk rotating together with the wheel for a unit time. The control unit 115 may perform odometry to estimate a displacement by analyzing the amount of location change with respect to time by using data obtained through the encoder and the gyro sensor. However, a displacement estimated on the basis of the encoder data may have an error from the actual displacement due to wheel slip or wear (a change in the wheel dynamic diameter). Therefore, when performing the odometry, the control unit 115 may perform correction for noise and error by using a predetermined algorithm (e.g., EKF) on the information collected from the wheel and gyro sensors, thereby outputting a result that tends to be close to an actual value. Such odometry may be particularly useful when it is impossible to determine the current location (localization) using a 2D laser scanner, which will be described later.

The 2D laser scanner may scan the surrounding environment by radiating a laser beam to the surroundings through a rotating reflector and sensing a reflected and returned signal. In this case, a detection result in the form of a point cloud may be output by analyzing the intensity of the reflected signal and a time difference between radiation and reception.

The 3D vision camera may calculate a distance to the object on the basis of a parallax between two cameras spaced apart as much as a predetermined distance, that is, a pixel distance between images captured by each camera. In this case, a texture projector that projects infrared light of a predetermined pattern may be provided so that a flat object of the same color (e.g., a white wall), and the like can be detected.

In general, 2D laser scanners may be used for mapping, navigation, object recognition, etc., and 3D cameras may be used during navigation, especially for avoiding obstacles, but this is exemplary and is not necessarily limited.

The loading unit 113 may be a means for loading the item to be transported, and may be in the form of a top plate on the upper part of the vehicle body itself or a table disposed on the top plate, a lift, a turntable rotating along a vertical axis, a fork lift, a conveyor, or a combination thereof. In the case of the fork lift, it may support telescopic and tilting functions, similar to a forklift.

The communication unit 114 may communicate with other components in the operation boundary 100, such as the facility 120 and the control device 140, may support communication between the logistics robots 110, and may communicate with the charger when performing a charging mission.

The control unit 115 may be the entity that performs overall control of each of the aforementioned components 111, 112, 113, 114, and may perform a current mission, a current location, a destination determination, path planning, a load unit control, and the like on the basis of the information obtained from the control device 140 through the communication unit 114.

Meanwhile, in an exemplary embodiment of the present disclosure, the logistics robot 110 may detect an object within the adjacent recognition range through a provided sensor, and in this case, the provided sensor may be included in the sensing unit 112.

The adjacent recognition range may be recognized through a sensor and may serve as a criterion for determining collision prediction of the logistics robot 110. For example, when another object is present within the adjacent recognition range, the logistics robot 110 can predict a collision.

When a collision is predicted due to the presence of another object within the adjacent recognition range, the logistics robot 110 may prevent the collision by adjusting the driving speed, such as by slowing down, making an emergency stop, or performing avoidance driving.

In particular, the adjacent recognition range may include a plurality of ranges that do not overlap each other, and the logistics robot 110 may adjust the driving speed differently depending on which range of the plurality of ranges another object exists in.

In this case, the plurality of ranges may include a first range and a second range located outwardly relative to the first range, and the logistics robot 110 may further decelerate the driving speed when another object is in the first range compared to when another object is in the second range.

The logistics robot 110 may adjust the adjacent recognition range according to an instruction of the control device 140, and the adjustment of the adjacent recognition range may be performed by, for example, adjusting the detection distance of the sensor itself or adjusting the range of sensing information used for surrounding recognition among sensing information through the sensor.

FIGS. 4a to 4d are views for illustrating an adjustment of an adjacent recognition range according to exemplary embodiments of the present disclosure.

First, referring to FIG. 4a, an example of a virtual map screen implemented on the basis of map information is shown. The virtual map screen may be implemented to correspond to at least a portion of the operation boundary 100. In addition, a display for the logistics robot 110 may be included on the virtual map screen, and a display for another object such as the facility 120 and the like may be included together.

Hereinafter, a process in which the logistics robot 110 departs from the departure point (A) toward the destination (B) via the first region of interest (C1) will be described as an example. Herein, at least one of the departure point (A) and the destination (B) may correspond to the facility 120 within the operation boundary 100.

In the process of the logistics robot 110 departing from the departure point (A) and moving to the first area of interest (C1), the map management unit 148 may display the adjacent recognition range (V) of the logistics robot 110 on the virtual map.

When the logistics robot 110 moves and enters the first region of interest (C1), the adjacent recognition range (V) may be reduced to at least one side, and in this case, a region where the width of the route along which the logistics robot 110 moves is narrow may be set as the first region of interest (C1).

When the width of the route along which the logistics robot 110 moves is narrow, another object may be located close to the logistics robot 110 in terms of distance, but since the risk of collision is low as long as the logistics robot 110 moves along a set route, in this case, the logistics robot 110 may continue to move without slowing down or bypassing the route by reducing the adjacent recognition range (V).

Meanwhile, in a process of the logistics robot 110 moving to the destination (B) after passing through the first region of interest (C1), the width of the movement route is wider again, and thus the adjacent recognition range (V) may be readjusted back to the state before the adjustment. According to the readjustment, the adjacent recognition range (V) may be expanded again, and according to the expansion of the adjacent recognition range (V), collision prediction of the logistics robot 110 may be performed according to a basic setting.

Meanwhile, when the logistics robot 110 enters the second region of interest (C2), the adjacent recognition range (V) may be expanded at least in one side. In this case, a region where the number of movements of another object is large may be set as the second region of interest (C2). Herein, another object may include people such as workers moving within the operation boundary 100, other logistics robots 110, production robots, and the like.

In this case, since the movements of another object are frequent in the second region of interest (C2), the risk of collision of the logistics robot 110 may be relatively high. Therefore, by expanding the adjacent recognition range (V), collision of the logistics robot 110 may be prevented more reliably.

In particular, as the adjacent recognition range (V) expands, it is possible not only to prevent the collision of the logistics robot 110 through the control such as slowing down the logistics robot 110 by predicting a collision in advance, but also to prevent the deterioration of the movement efficiency of the logistics robot 110 by stopping the logistics robot 110 urgently just before the collision.

Next, FIG. 4b may be assumed to represent another portion of the virtual map screen shown in FIG. 4a, and may show a virtual map screen for a process in which the logistics robot 110 moves from the departure point (A) to the destination (B) via the first region of interest (C1).

Referring to FIG. 4b, the first region of interest (C1) may be set in consideration of the location of the another fixed object within the corresponding region, and for example, a region in which three or more fixed other objects are located may be set as the first region of interest (C1).

When a large number of fixed other objects are present within a region, a large number of other objects may be present near the logistics robot 110, but the actual risk of collision may not be great because other objects are fixed.

Accordingly, when the logistics robot 110 enters the first region of interest (C1), the adjacent recognition range (V) may be reduced to at least one side, such that a collision is not predicted even when other objects are relatively close to the logistics robot 110.

Meanwhile, the adjacent recognition range (V) may be divided into a plurality of ranges that do not overlap each other and, for example, may be divided into a first range (V1) and a second range (V2) outwardly relative to the first range (V1). In this case, the driving speed of the logistics robot 110 may be adjusted differently depending on which of the first range (V1) and the second range (V2) another object exists in.

In particular, the driving speed of the logistics robot 110 may be further reduced when another object is present within the first range (V1) than when present within the second range (V2), considering that the risk of collision of the logistics robot 110 is greater when another object is present within the first range (V1) than when present within the second range (V2).

Meanwhile, in the process of adjusting the adjacent recognition range (V), the first range (V1) and the second range (V2) may be adjusted together, or only one of the first range (V1) and the second range (V2) may be adjusted. In particular, when reducing the adjacent recognition range (V), the first range (V1) may be maintained as it is since it is a range with a high risk of collision and only the second range (V2) may be reduced, thereby preventing unnecessarily impeding the movements of the logistics robot 110.

Next, FIG. 4c may be assumed to represent another portion of the virtual map screen shown in FIG. 4a.

Referring to FIG. 4c, the second region of interest (C2) may be set in consideration of the set speed of the logistics robot 110 in the corresponding region. For example, a region in which the logistics robot 110 moves at high speed may be set as the second region of interest (C2), and in this case, the adjacent recognition range (V) may be expanded in the moving direction (e.g., forward) of the logistics robot 110.

In a region where the set speed of the logistics robot 110 is high, the logistics robot 110 may move at high speed, so the possibility of a collision may increase even when another object is present relatively far away from the logistics robot 110. Accordingly, the adjacent recognition range (V) may be expanded in the moving direction of the logistics robot 110 so that collision may be predicted early.

Next, FIG. 4d may be assumed to represent another portion of the virtual map screen shown in FIG. 4a.

Referring to FIG. 4d, the second region of interest (C2) may be set in consideration of the type of other objects within the corresponding region. For example, a region in which an openable door exists on one side may be set as the second region of interest (C2), in which case the adjacent recognition range (V) may be expanded in the direction in which the door exists. In addition, when another fixed object exists on the opposite side to the direction in which the door exists, the adjacent recognition range (V) may be expanded in the direction in which the door exists, but may be reduced in the opposite direction.

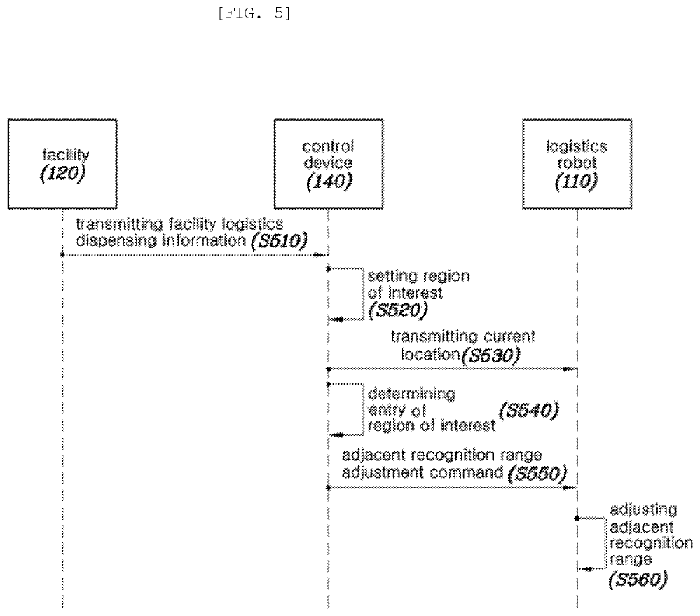

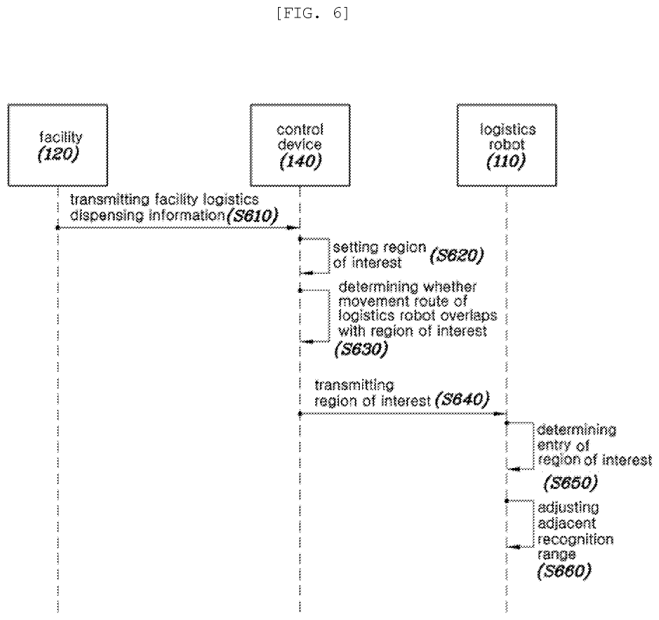

Hereinafter, a control process of a logistics system will be sequentially described with reference to FIGS. 5 to 6.

FIGS. 5 to 6 are sequence diagrams of a logistics system according to exemplary embodiments of the present disclosure.

Referring to FIG. 5, the control device 140 may receive facility logistics dispensing information from the facility 120 (S510), and may set the region of interest by reflecting the received facility logistics dispensing information in the map information (S520).

In addition, the control device 140 may receive the current location from the logistics robot 110 (S530), and may determine whether the logistics robot 110 enters the region of interest within the operation boundary 100 on the basis of the received location of the logistics robot 110 (S540).

When the logistics robot 110 enters the region of interest within the operation boundary 100, the control device 140 may direct to adjust the adjacent recognition range through outputting an adjacent recognition range adjustment command (S550).

The logistics robot 110 receiving the adjacent recognition range adjustment command may adjust the adjacent sensing range according to the command (S560).

Referring to FIG. 6, the control device 140 may receive the facility logistics dispensing information from the facility 120 as shown in FIG. 5 (S610), and may set a region of interest by reflecting the received facility logistics dispensing information in the map information (S620).

However, unlike what is explained with reference to FIG. 5, the control device 140 may determine whether the movement route of the logistics robot 110 overlaps with the set region of interest (S630), and may transmit the region of interest to the logistics robot when the movement route of the logistics robot 110 overlaps with the set region of interest (S640).

The logistics robot 110 receiving the region of interest may determine by itself whether to enter the region of interest (S650), and may adjust the adjacent recognition range when entering the region of interest (S660).

According to various exemplary embodiments of the present disclosure as described above, it is possible to efficiently perform the control of collision avoidance of a logistics robot by adjusting an adjacent recognition range, which is a criterion for determining a collision prediction by reflecting features for each region within an operation boundary.

In particular, it is possible to prevent a logistics robot from slowing down because of unnecessarily performing the control of collision prevention by reducing an adjacent recognition range when the risk of collision is low, thereby improving the movement efficiency of the logistics robot.

In addition, by expanding an adjacent recognition range when the risk of collision is high, it is possible to perform collision prevention control while securing the movement efficiency of logistics robots.

Although shown and described in relation to specific exemplary embodiments of the present disclosure, it will be apparent to those skilled in the art that the present disclosure may be variously improved and modified within a range not departing from the technical spirit of the present disclosure provided by the following patent claims.

1. A control device, the device comprising:
a map management unit for setting at least one region within an operation boundary as a region of interest on the basis of map information corresponding to a preset operation boundary; and
a monitoring unit for determining whether a logistics robot has entered the set region of interest and for directing to adjust an adjacent recognition range of the logistics robot on the basis of a determination result of whether the logistics robot has entered the set region of interest.

2. The device of claim 1, wherein the region of interest comprises at least a first region of interest and a second region of interest, and
wherein the monitoring unit directs to adjust the adjacent recognition range when the logistics robot has entered the region of interest, but directs to differently adjust the adjacent recognition range depending on which of the first interest region and the second interest region the logistics robot has entered.

3. The device of claim 2, wherein the monitoring unit directs to reduce the adjacent recognition range to at least one side when the logistics robot has entered the first region of interest.

4. The device of claim 3, wherein the map information comprises at least one of a location of a fixed object for each region within the operation boundary and a width of a route, along which the logistics robot moves for each region within the operation boundary, and
wherein the map management unit sets the first region of interest on the basis of at least one of the location of the fixed object and the width of the route.

5. The device of claim 2, wherein the monitoring unit directs to expand the adjacent recognition range to at least one side when the logistics robot has entered the second region of interest.

6. The device of claim 5, wherein the map information comprises at least one of the number of movements of an object for each region within the operation boundary, a set speed of the logistics robot for each region within the operation boundary, and a type of the object for each region within the operation boundary, and
wherein the map management unit sets the second region of interest on the basis of at least one of the number of movements, the set speed, and the type.

7. The device of claim 1, wherein the monitoring unit directs to readjust the adjacent recognition range back to before the adjustment when the logistics robot, which has entered the region of interest, deviates from the region of interest.

8. A logistics system, the system comprising:
a logistics robot for moving within a preset operation boundary and for detecting an object within an adjacent recognition range through a sensor provided therein; and
a control device for setting at least one region within the operation boundary as a region of interest on the basis of map information corresponding to the operation boundary, for determining whether the logistics robot has entered the at least one region of interest, and for directing to adjust the adjacent recognition range on the basis of a determination result of whether to the logistics robot has entered the at least one region of interest.

9. The system of claim 8, wherein the logistics robot adjusts a driving speed when an object is present within the adjacent recognition range.

10. The system of claim 9, wherein the adjacent recognition range comprises a plurality of ranges that do not overlap each other, and
wherein the logistics robot differently adjusts the driving speed depending on which range of the plurality of ranges the object exists in.

11. The system of claim 10, wherein the plurality of ranges comprises a first range and a second range located outwardly relative to the first range, and
wherein the logistics robot further decelerates the driving speed when the object is present in the first range compared to when the object is present in the second range.

12. A logistics system, the system comprising:
a logistics robot for moving within a preset operation boundary and for detecting an object within an adjacent recognition range through a sensor provided therein; and
a control device for setting at least one region within the operation boundary as a region of interest on the basis of map information corresponding to the operation boundary, and for transmitting the region of interest to the logistics robot,
wherein the logistics robot determines whether the logistics robot has entered the region of interest and adjusts the adjacent recognition range on the basis of a determination result of whether the logistics robot has entered the region of interest.

13. The system of claim 12, wherein the logistics robot adjusts a driving speed when an object is present within the adjacent recognition range.

14. The system of claim 13, wherein the adjacent recognition range comprises a plurality of ranges that do not overlap each other, and
wherein the logistics robot adjusts the driving speed differently depending on which range of the plurality of ranges the object exists in.

15. The system of claim 14, wherein the plurality of ranges comprises a first range and a second range located outwardly relative to the first range, and
wherein the logistics robot further decelerates the driving speed when the object is present in the first range compared to when the object is present in the second range.

16. The system of claim 12, wherein the control device transmits the region of interest to the logistics robot when a movement route of the logistics robot overlaps with the region of interest.
